(19) United States
(12) Patent Application Publication
(10) Pub. No.: US 2005/0128365 A1
(43) Pub. Date: Jun. 16, 2005

(54) Vehicle display device with infrared transmission

(76) Inventor: Tai-Hsiung Wu, Taoyuan (TW)

Correspondence Address: DELLETT AND WALTERS, P. O. BOX 2786, PORTLAND, OR, 97208-2786, US

(21) Appl. No.: 10/737,153

(22) Filed: Dec. 15, 2003

(51) Int. Cl. H04N 5/64

(52) U.S. Cl. 348/837

(57) ABSTRACT

A vehicle display device mounted inside a vehicle has an input interface to which a video decoder, an audio amplifier and an infrared earphone transmitter are connected. Video signals received by the input interface are processed and displayed on a panel through a panel interface. In another aspect, audio signals from the input interface are able to be directly broadcast via speaker or converted to infrared signals. With the audio infrared signals, users wearing appropriate earphones can use an infrared earphone to receive and listen to the audio signals whereby the vehicle driver not wearing the earphones will not be influenced by the sounds.

### BACKGROUND OF THE INVENTION

1. Field of the Invention

The present invention relates to a vehicle display device, and more particularly to a vehicle device capable of wirelessly transmitting audio signals via infrared transmission technique to an earphone.

2. Description of Related Art

Vehicle display devices (monitor) have become popular accessories for vehicles, and may be used in a wide variety of applications. For example, the display device may be used in a vehicle as a computer monitor, a navigating system display, a television, etc. The vehicle display devices may be mounted at any of various locations within the vehicle, depending on the vehicle configuration and the intended use of the monitor. The most desired location where display devices may be mounted is on the ceiling of the vehicle.

In some situations, the vehicle display device is used for other passengers not the driver. However, the sound broadcast from the display device may still distract the vehicle driver and affect the safety of the vehicle. Therefore, it is desired to provide a way to obviate the aforementioned drawback.

### SUMMARY OF THE INVENTION

The main objective of the present invention is to provide a vehicle display device that is able to transmit audio signals via the infrared technique to prevent possible distraction of the driver, meanwhile other passengers still can listen to the display device by use of proper earphones.

Other objects, advantages and novel features of the invention will become more apparent from the following detailed description when taken in conjunction with the accompanying drawings.

### BRIEF DESCRIPTION OF THE DRAWINGS

FIG. 1 is a plan view of a vehicle display device in accordance with the present invention;

FIG. 2 is a circuit block diagram of the vehicle display device in accordance with the present invention;

FIGS. 3A-3G show a detailed circuit diagram of an input interface shown in FIG. 1;

FIGS. 4A-4C show a detailed circuit diagram of an MCU shown in FIG. 1;

FIGS. 5A-5D show a detailed circuit diagram of a video decoder in FIG. 1;

FIGS. 6A-6B show a detailed circuit diagram of a panel interface of FIG. 1;

FIG. 7 is a circuit diagram of an on-screen display (OSD) circuit in accordance with the present invention;

FIGS. 8A-8B show a circuit diagram of an audio amplifier of FIG. 1;

FIGS. 9A-9E show a circuit diagram of an infrared earphone transmitter of FIG. 1; and

FIGS. 10A-10D is a circuit diagram of an inverter and power circuit of FIG. 1.

### DETAILED DESCRIPTION OF THE PREFERRED EMBODIMENT

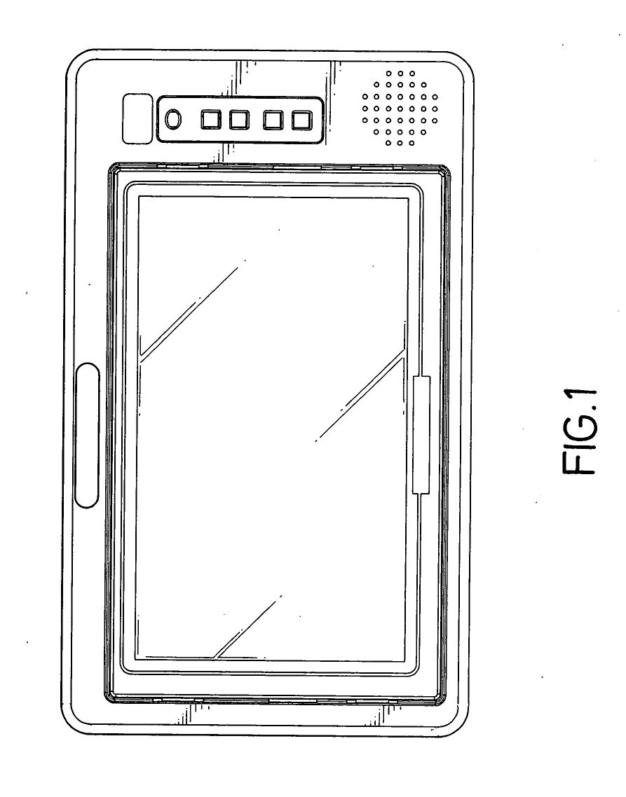

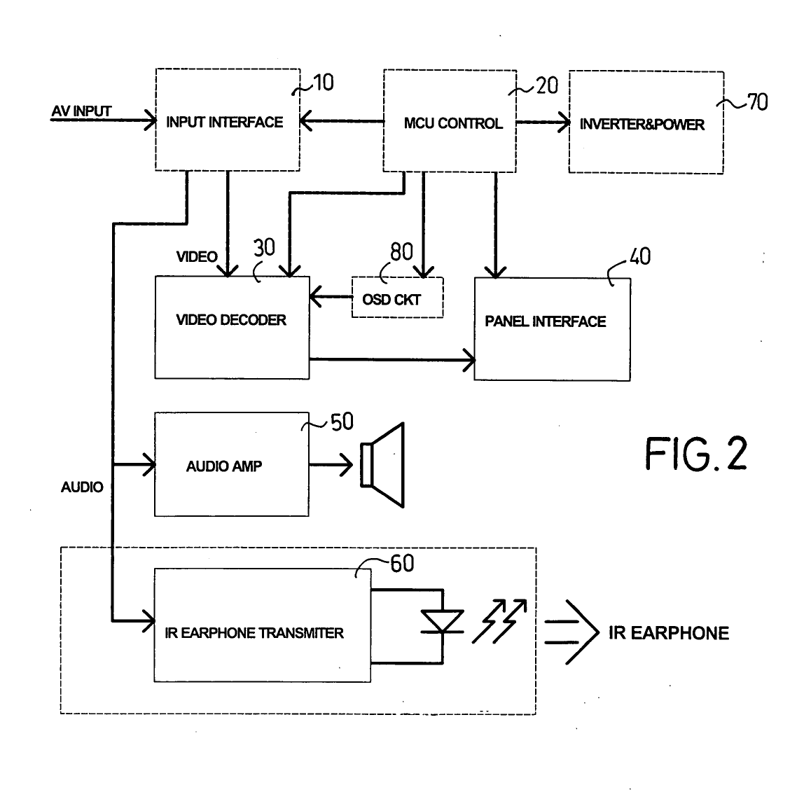

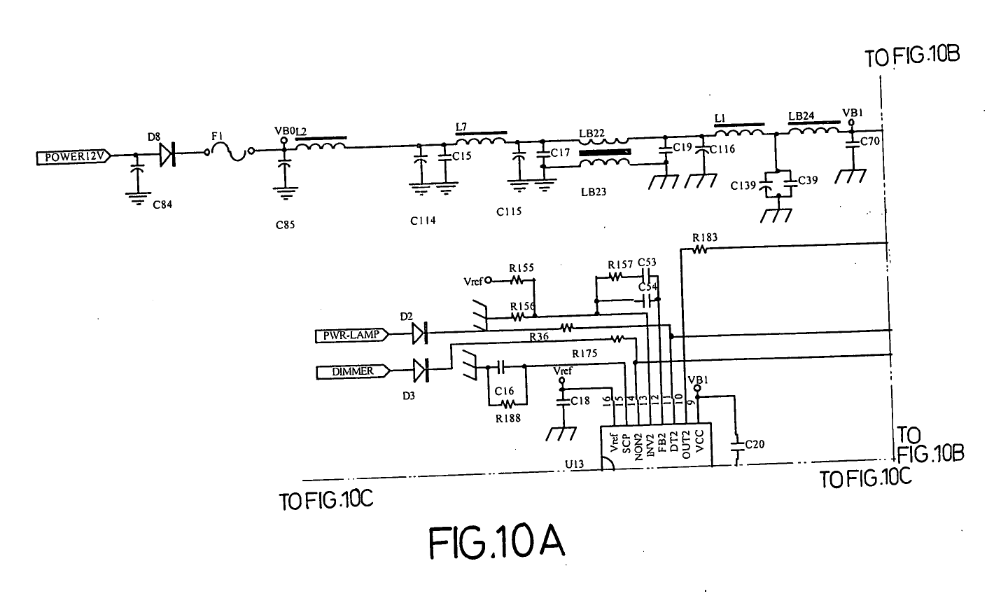

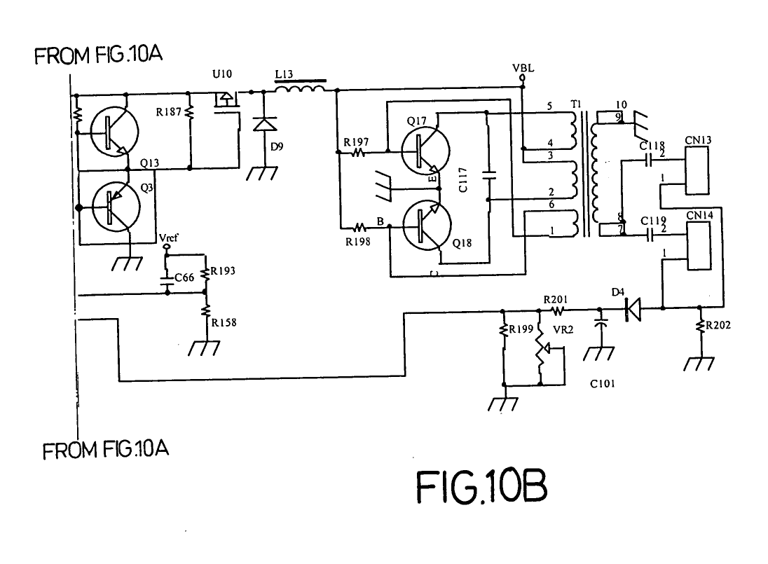

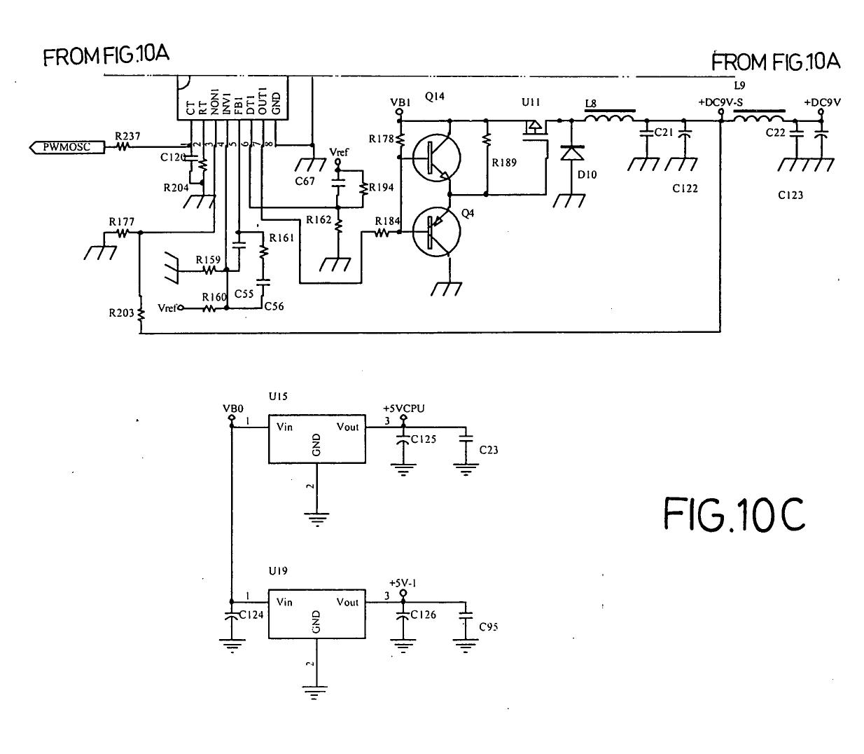

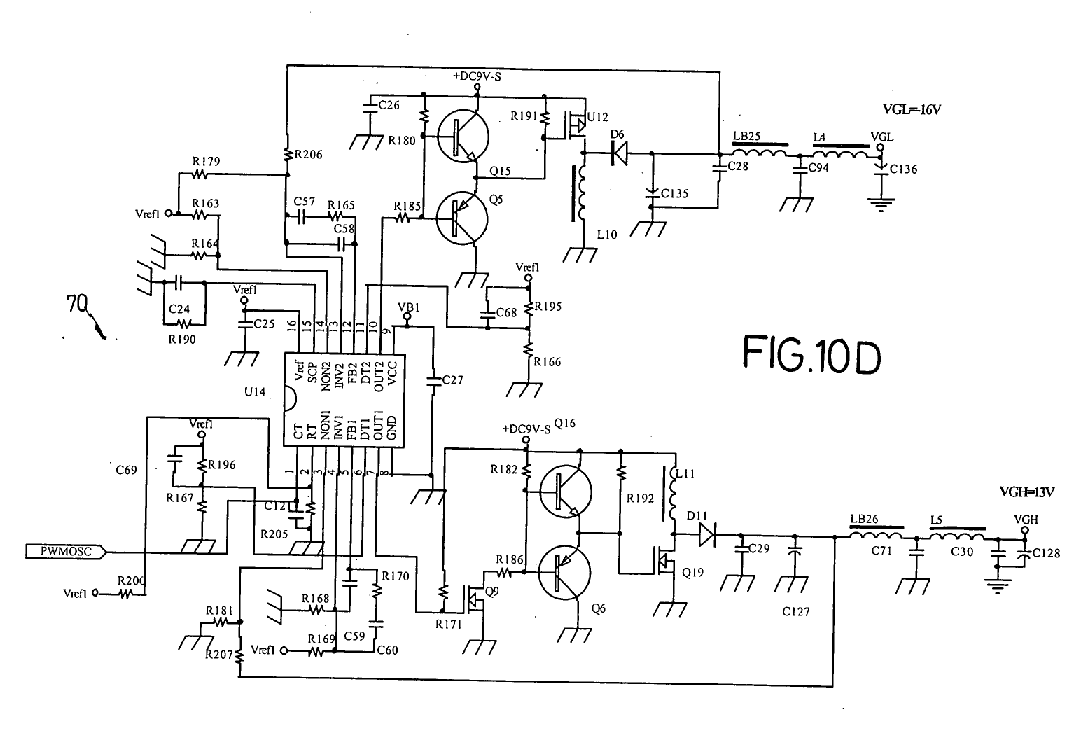

With reference to FIGS. 1 and 2, a vehicle display device in accordance with the present invention mainly comprises an input interface (10), a micro-control unit (20), a video decoder (30), a panel interface (40), an audio amplifier (50) and an infrared earphone transmitter (60). An inverter and power unit (70) provides operating voltages to the foregoing elements, where the detailed circuit diagram of the inverter and power unit (70) is illustrated in FIGS. 10A-10D.

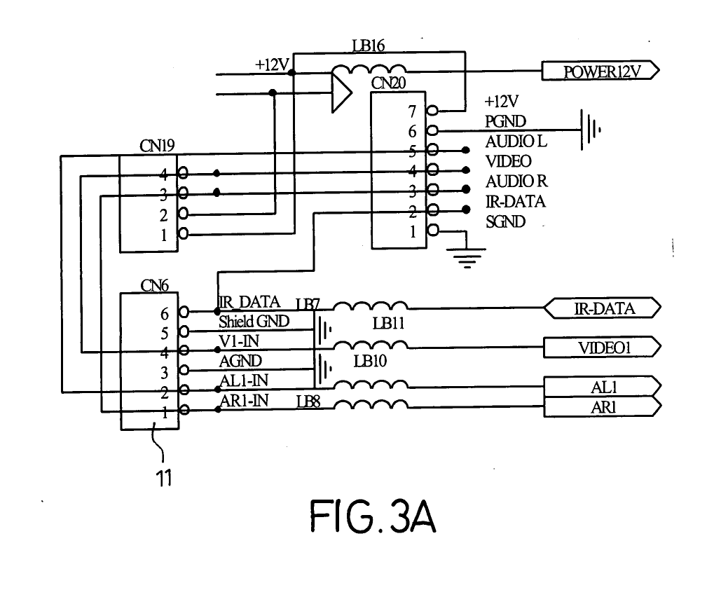

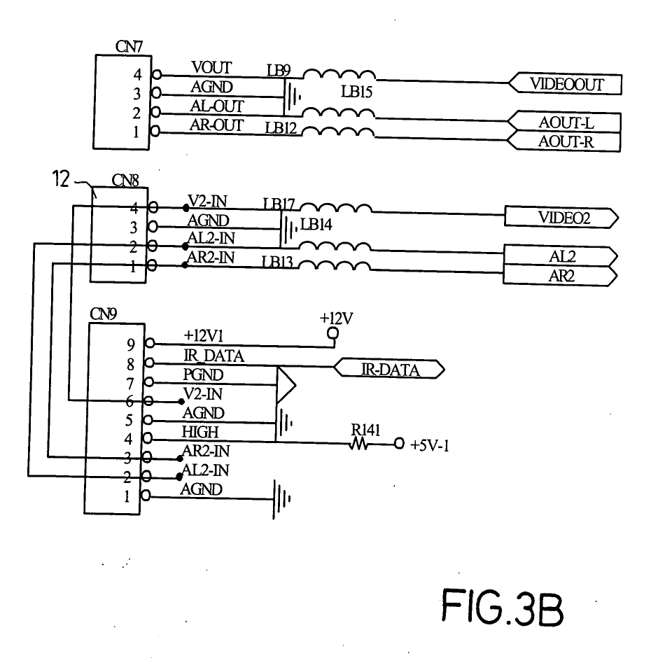

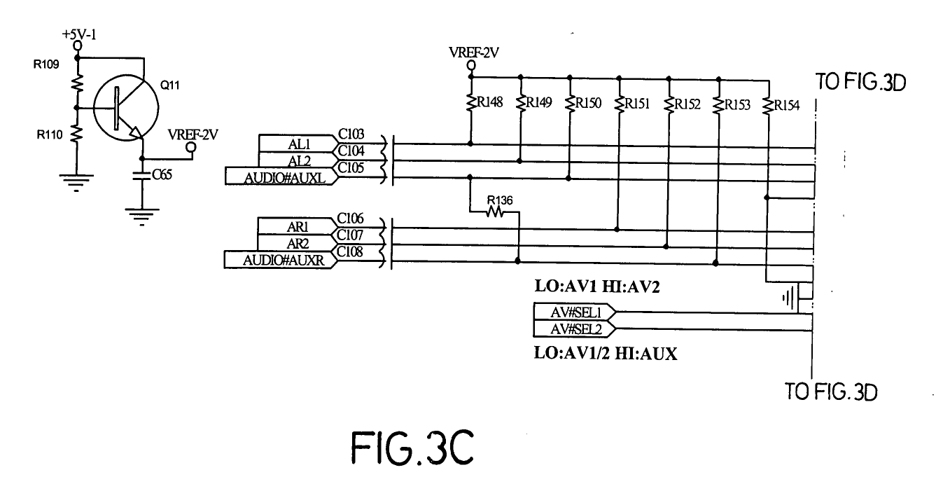

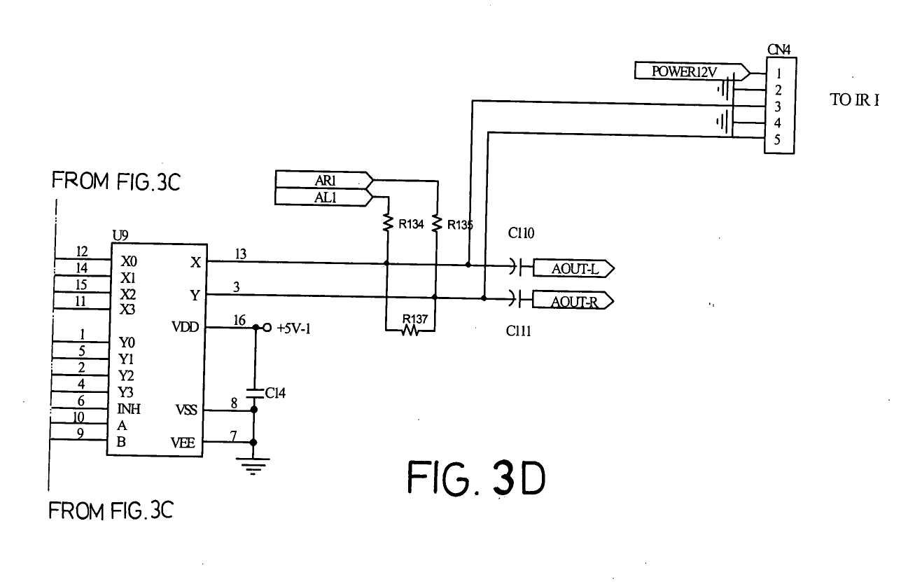

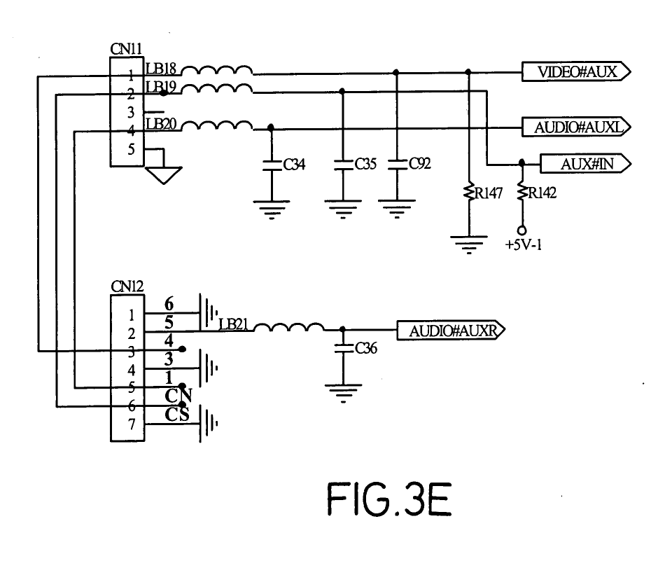

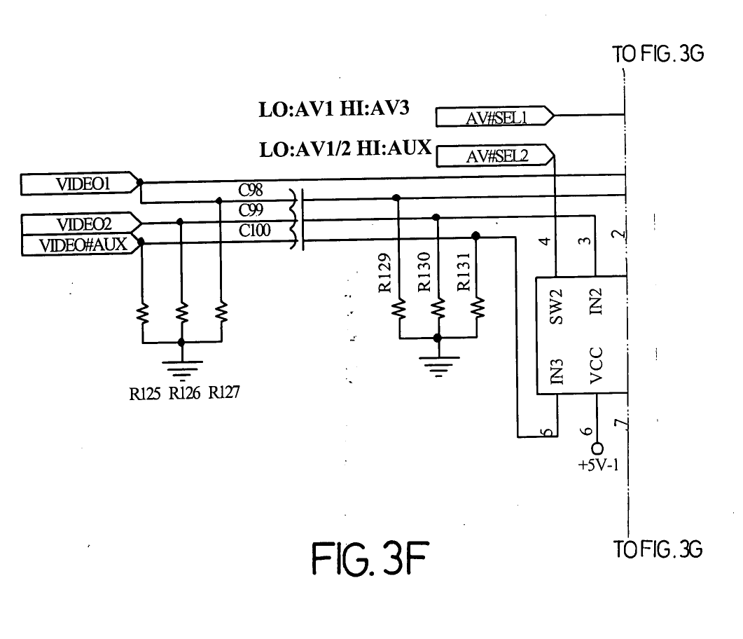

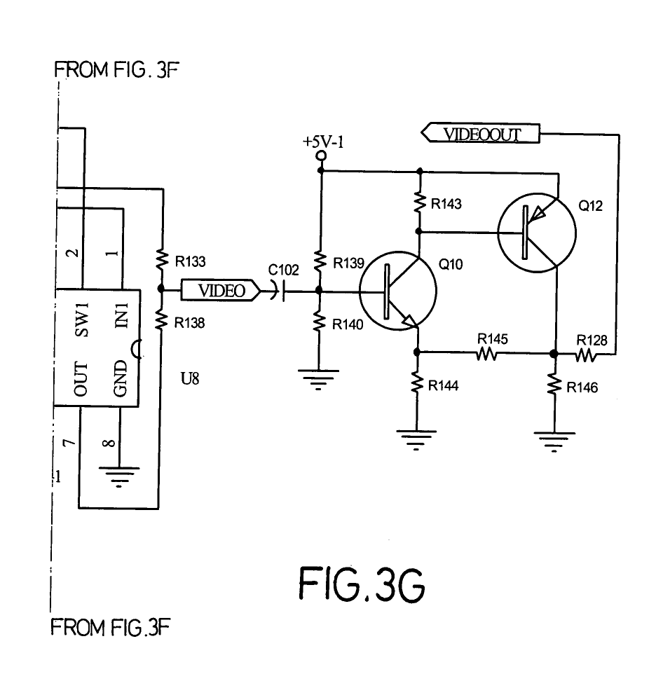

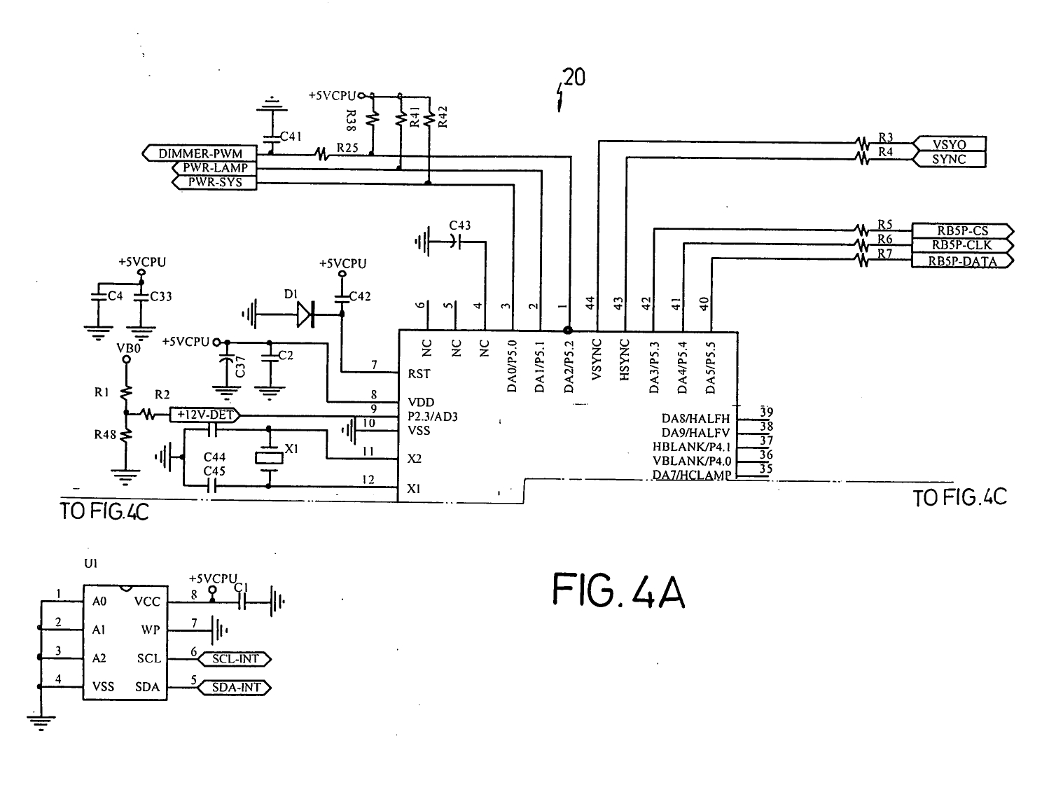

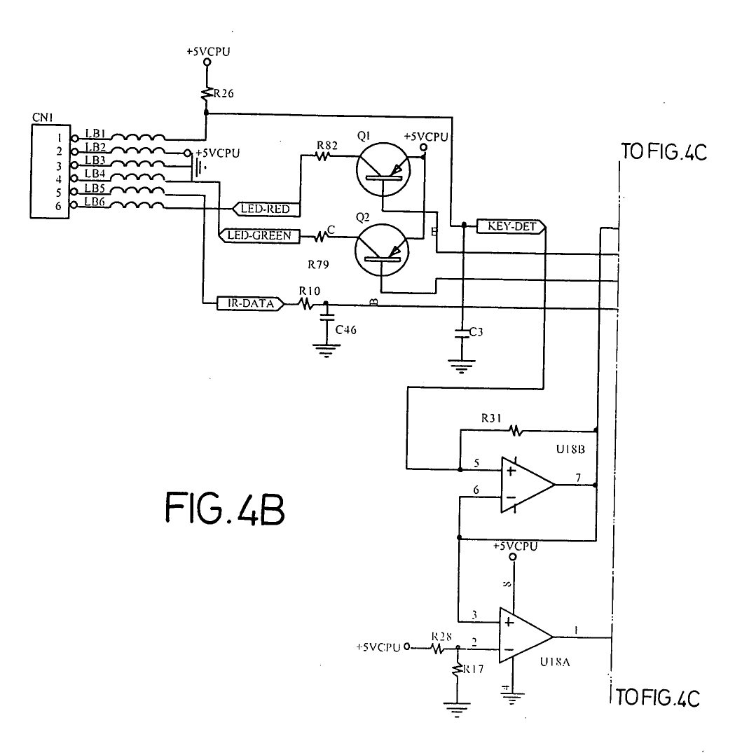

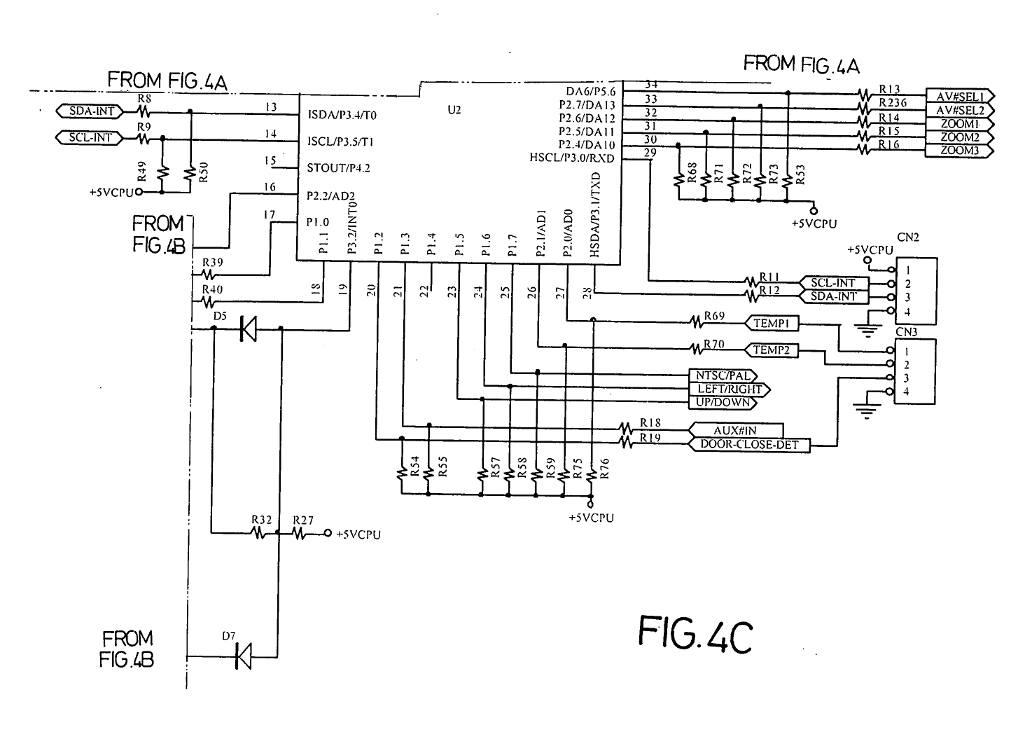

With reference to FIGS. 1 and 3A-3G, audio video (AV) signals can be input to the vehicle display device through either a first connector (11) or a second connector (12) of the input interface (10). Based on the control commands of the micro-control unit (20), the desired AV signal is selected from one of the two connectors (11, 12). The detailed circuits of the micro-control unit (20) are depicted in FIGS. 4A-4C, wherein the operations status table of the micro-control unit (20) is shown as follows:

| PORT | I/O | initial value | |
|---|---|---|---|
| VOLUME-PWM | | PWM = 0 | |
| PWR-LAMP | O | HIGH | LO: POWER ON |
| PWR-SYS | | HIGH | LO: POWER ON |
| +12 V = DET | I | A/D | |
| KEY-DET | I | A/D | |
| LED-RED | O | HIGH | |
| LED-GREEN | O | HIGH | |
| IR-DATA | I | INT0 | |
| DOOR-CLOSE-DET | I | | |
| AUX-IN | I | | |
| VIDEO-IN-DET | I | | |
| RB5P-DATA | O | HIGH | |
| RB5P-CLK | O | HIGH | |
| RB5P-CS | O | HIGH | |
| UP/DOWN | O | HIGH | LO: UP->DOWN |
| LEFT/RIGHT | O | HIGH | LO: LEFT->RIGHT |
| NTSC/PAL | O | HIGH | HIGH: NISC/LO: PAL |
| ZOOM1 | O | HIGH | |
| ZOOM2 | O | HIGH | |
| ZOOM3 | O | HIGH | |

The video component of the AV signals is sent to the video decoder (30), and the audio component is transmitted to the audio amplifier (50) and the IR earphone transmitter (60).

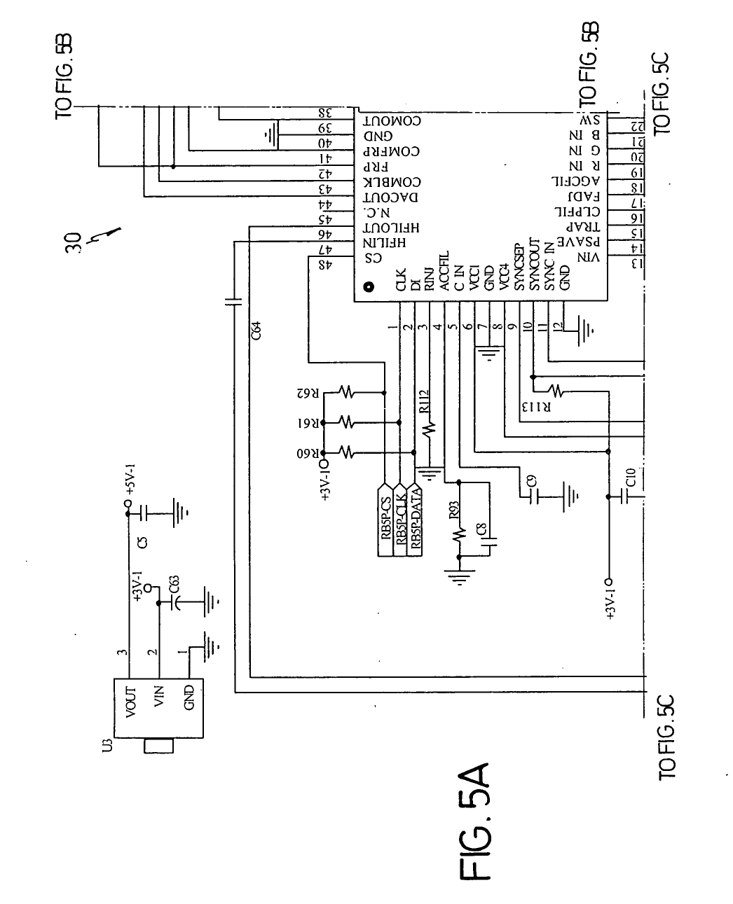

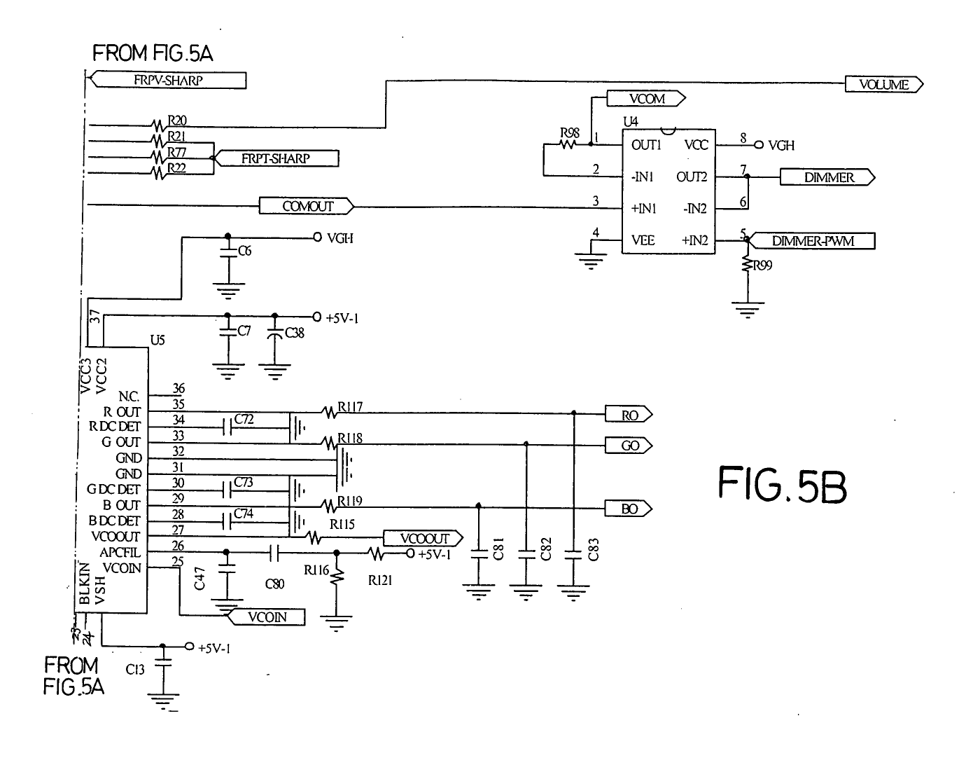

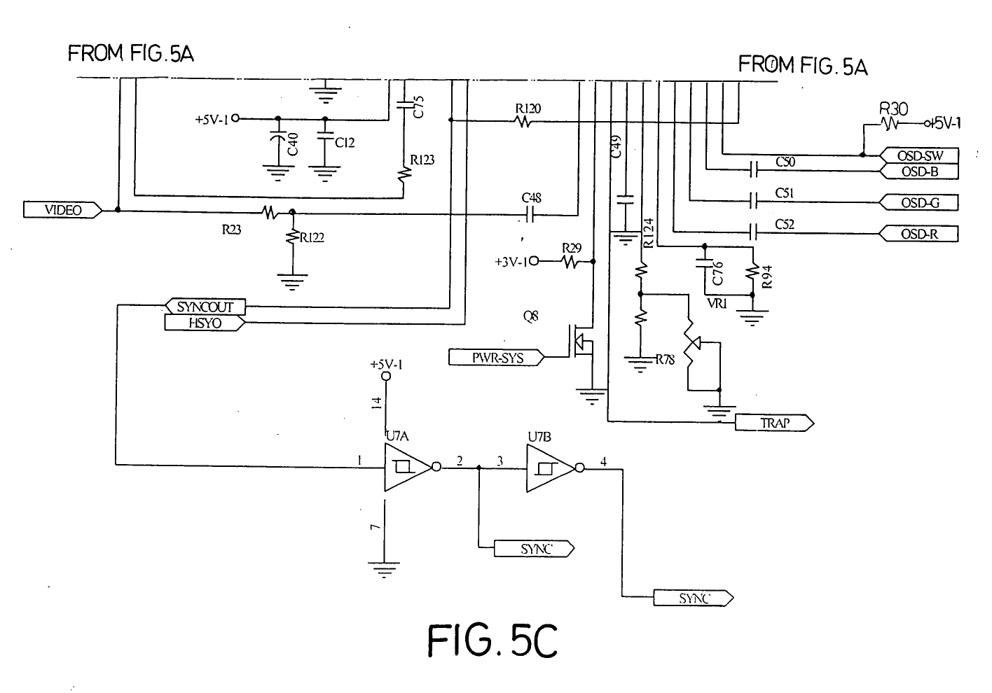

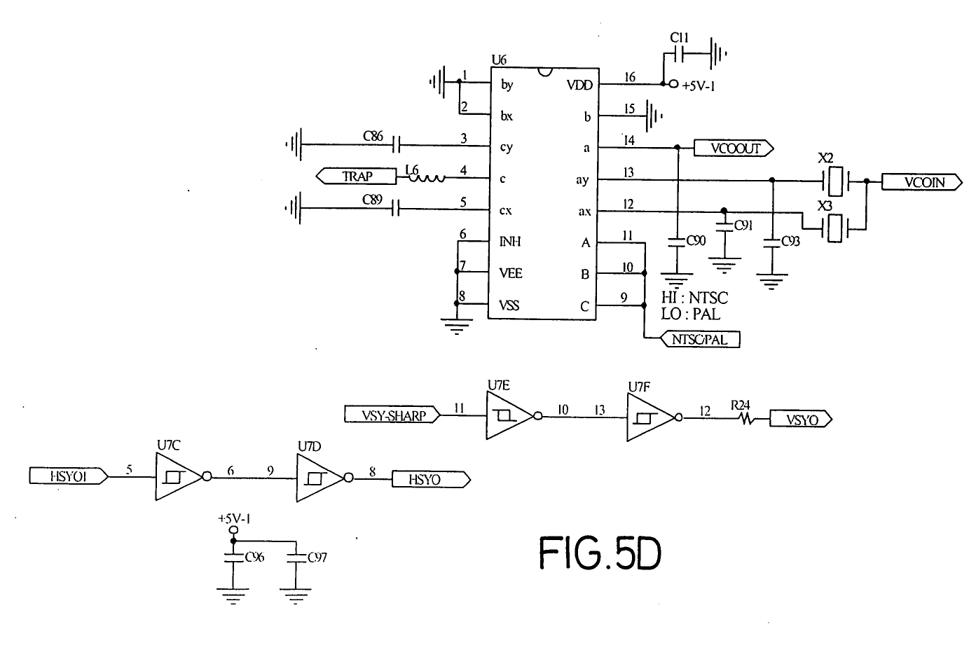

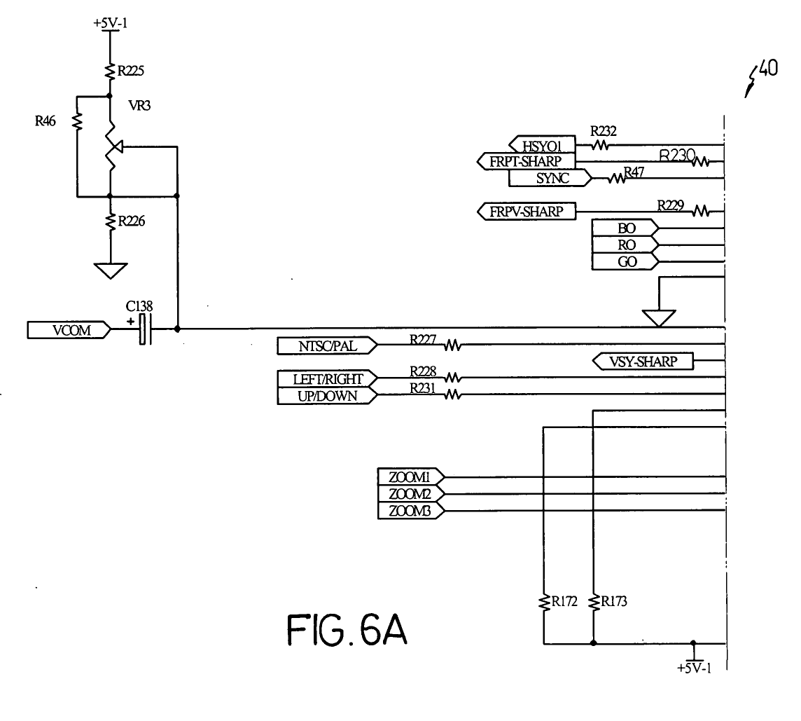

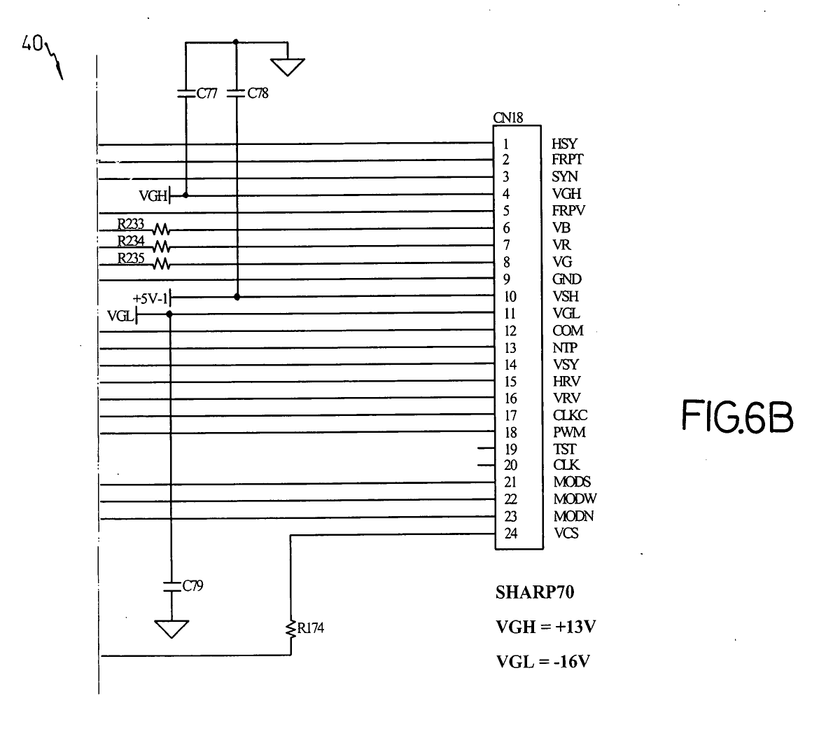

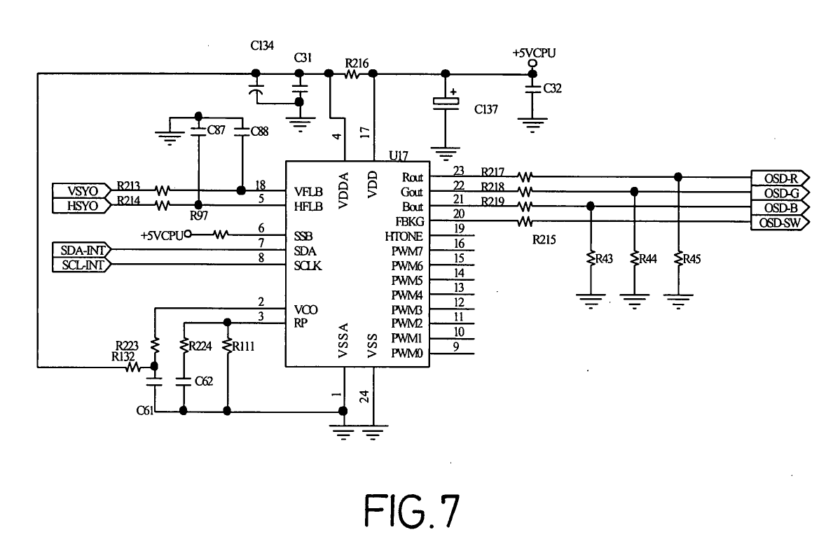

With reference to FIGS. 5A to 6B, after the video decoder (30) decodes the received video signals, the decoded video data are then transmitted to the panel interface (40) through which an LCD display panel (not shown) is allowing to show the video images. As shown in FIGS. 1 and 7, an on-screen display (OSD) circuit (80) is further connected to the video decoder (30) and controlled by the micro-control unit (20). The OSD circuit (80) provides a function that the setting parameters relevant to the LCD display panel is directly shown on the panel with which a user is able to adjust the setting such as the vertical size or horizontal size of displayed images.

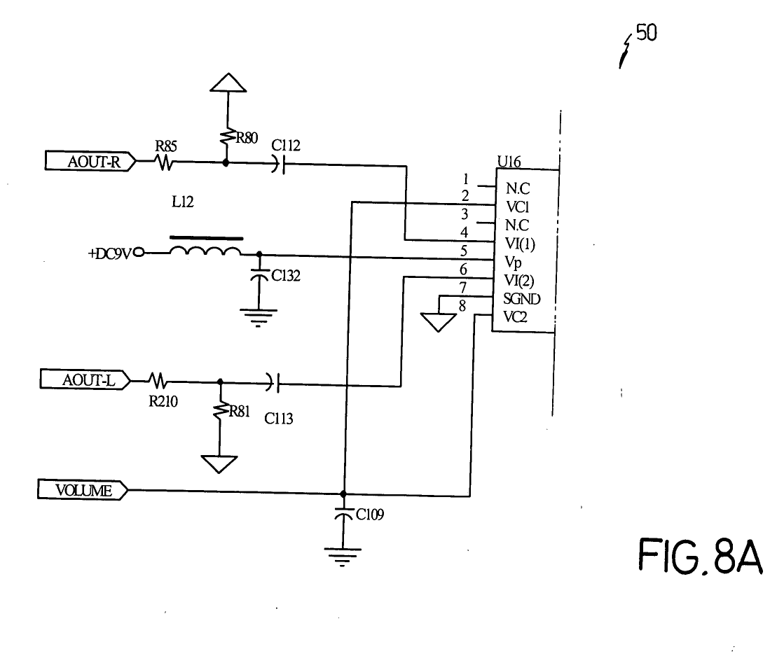

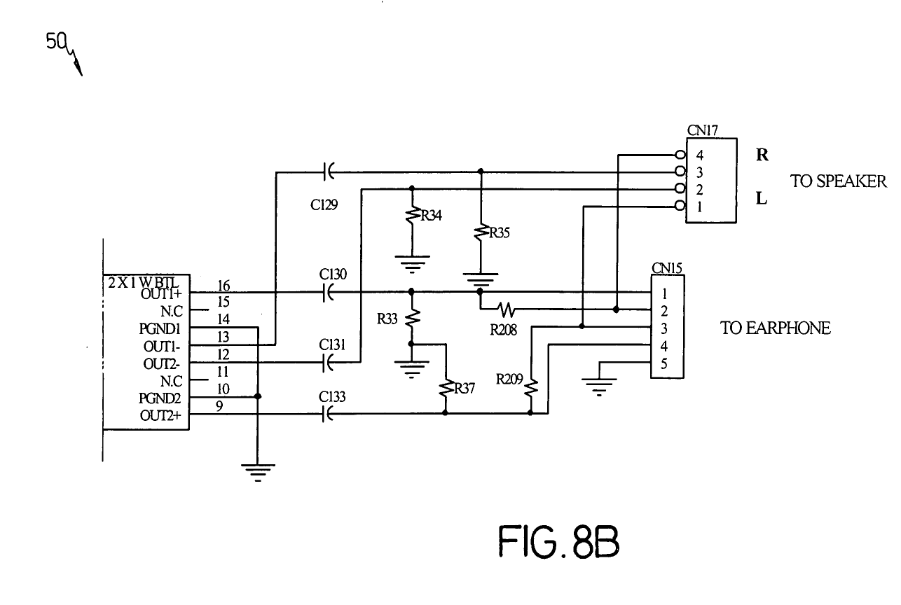

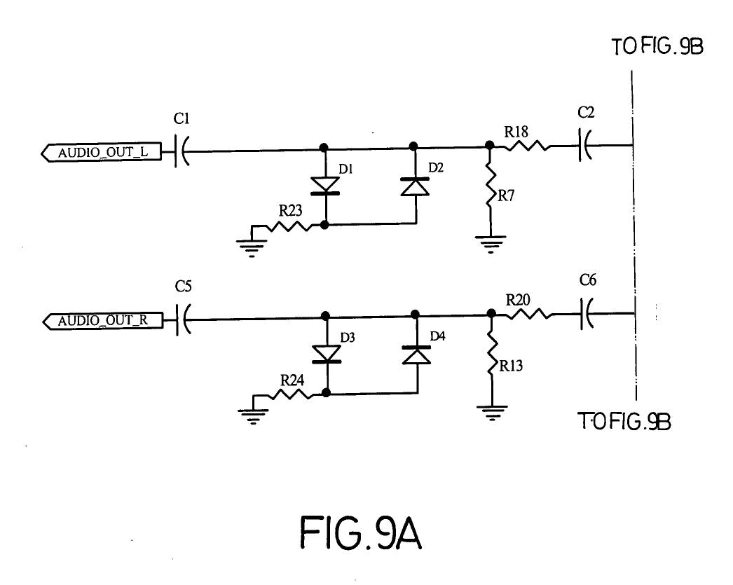

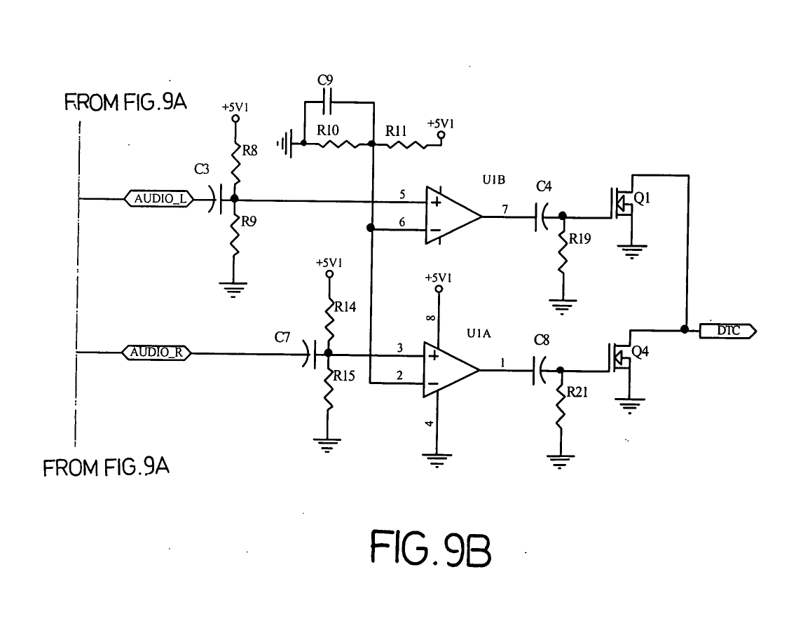

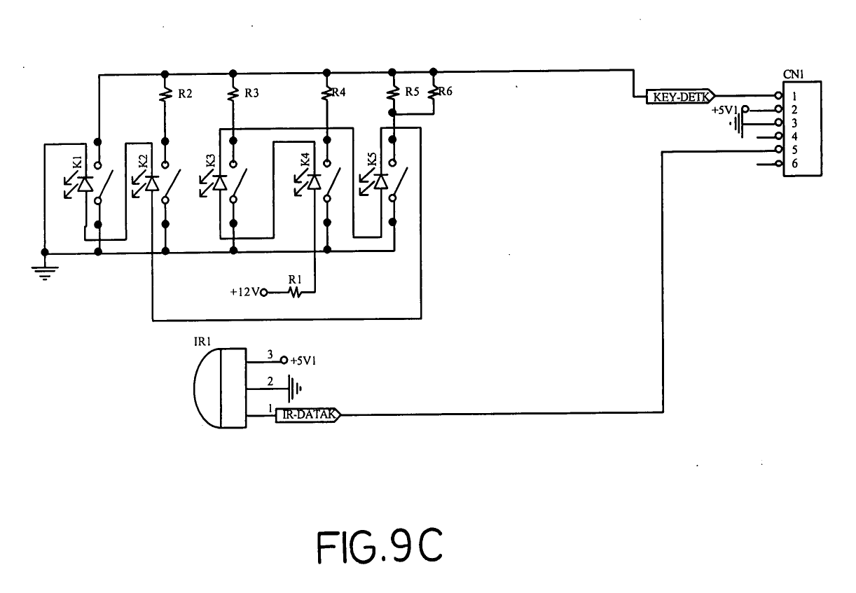

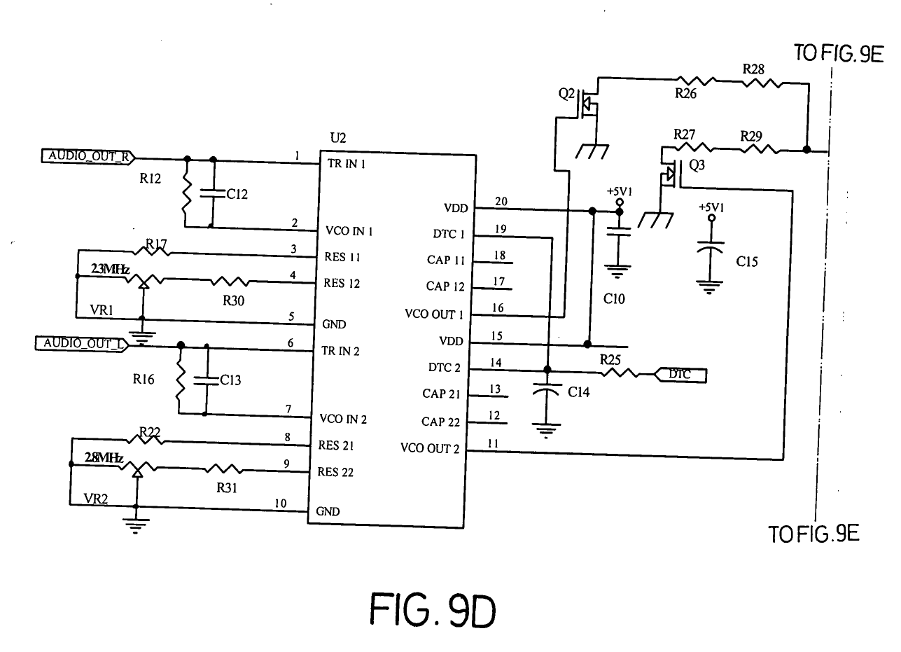

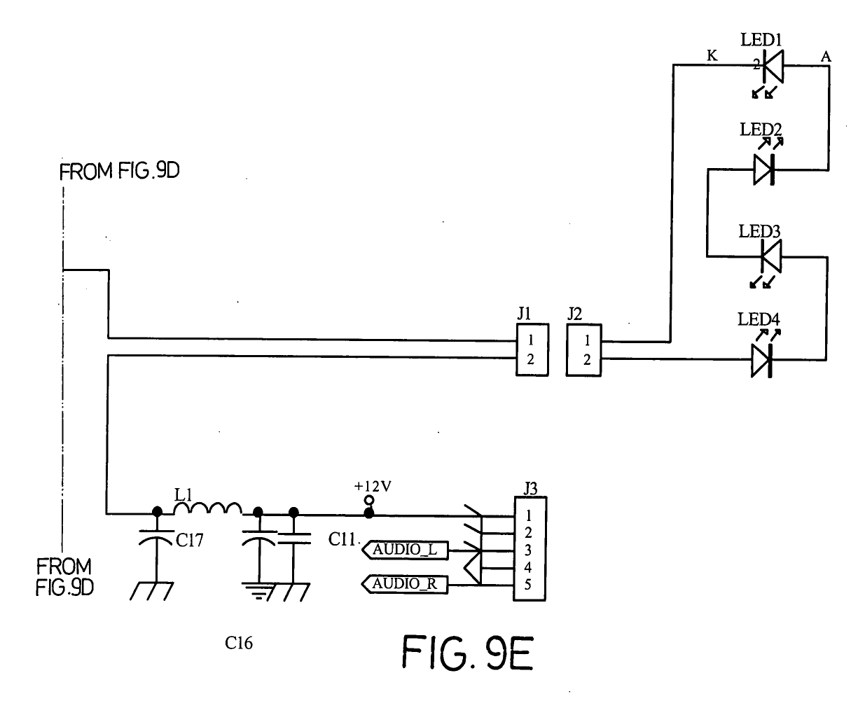

With reference to FIGS. 8A to 9E, the audio signals from the input interface (10) are input to the audio amplifier (50) and the IR earphone transmitter (60). The amplified audio signals from the amplifier (50) can be broadcast via a speaker (not shown). In another aspect, the audio signals are converted to infrared signals by the IR earphone transmitter (60) and then emitted wirelessly to an IR earphone. Through the use of the IR earphone, vehicle passengers still can listen to sounds while they are watching the videos on the display device, yet the driver not wearing such an earphone is not distracted by the sounds enjoyed by the passengers. It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A vehicle display device comprising:
an input interface for receiving AV signals composed of video signals and audio signals;
a video decoder connected to the input interface to receive and decode the video signals;
a panel interface connected to the video decoder, wherein the decoded video signals are transmitted to and displayed on a display panel through the panel interface;
a micro-control unit connected to the input interface, the video decoder and the panel interface for controlling the display of video;
an audio amplifier connected to the input interface to receive the audio signals;
an infrared earphone transmitter connected to the input interface to receive the audio signals, wherein the audio signals received by the infrared earphone transmitter are converted to infrared signals and then adapted to emit to an infrared earphone; and
a speaker connected to the input interface through the audio amplifier for broadcasting the amplified audio signals;
wherein the audio signals from the input interface are able to be output via said speaker or said infrared earphone transmitter based on control commands of the micro-control unit.

2. The vehicle display device as claimed in claim 1, wherein an on-screen display (OSD) circuit is connected to the micro-control unit and the video decoder to provide a function that shows setting parameters of the display panel on the display panel.

3. The vehicle display device as claimed in claim 1, wherein the vehicle display device further has an inverter and power circuit to provide operating voltages.

4. The vehicle display device as claimed in claim 2, wherein the vehicle display device further has an inverter and power circuit to provide operating voltages.
